(19) United States
(12) Patent Application Publication
(10) Pub. No.: US 2026/0166365 A1
(43) Pub. Date: Jun. 18, 2026

(54) SPACE WINGS SUIT

(71) Applicants: Frederick Neil Herrmann, Kailua Kona, HI (US); Caleb Smith, Kailua Kona, HI (US); Kapono Corpus, Kailua Kona, HI (US); Alexander Lim, Kailua Kona, HI (US); Christian Williams, Kailua Kona, HI (US); Brandon Buehler, Kailua Kona, HI (US)

(72) Inventors: Frederick Neil Herrmann, Kailua Kona, HI (US); Caleb Smith, Kailua Kona, HI (US); Kapono Corpus, Kailua Kona, HI (US); Alexander Lim, Kailua Kona, HI (US); Christian Williams, Kailua Kona, HI (US); Brandon Buehler, Kailua Kona, HI (US)

(21) Appl. No.: 19/415,739

(22) Filed: Dec. 10, 2025

Related U.S. Application Data
(60) Provisional application No. 63/734,060, filed on Dec. 14, 2024.

(51) Int. Cl. A63B 21/00

(52) U.S. Cl. CPC A63B 21/4025; A63B 21/4035

(57) ABSTRACT

A wings suit includes: a base portion; and first and second wing portions extending from the base portion. Each of the first and second wing portions includes: an upper portion protruding above a top of the base portion; a wire cable having a first end protruding from an opening in the exterior layer and a second end securely connected to the interior layer; a handle attached to the first end of the wire cable; and an arm strap adjustably connected to the exterior layer. The base portion includes: first and second shoulder straps adjustably connected to the exterior layer and extending from the top in a vertical direction; and a waist strap adjustably connected to the exterior layer and extending in a horizontal direction below the first and second should straps.

### CROSS-REFERENCE TO RELATED APPLICATIONS

The present application claims the benefit of Provisional Ser. No. 63/734,060 filed on Dec. 14, 2024, the contents all of which are incorporated herein by reference.

### TECHNICAL FIELD

The technical field generally relates to a suit for use in an environment with zero or near zero gravity such as a space station.

### BACKGROUND

Human muscles lose both mass and strength during space flight. After a 2-week space flight, muscle mass can diminish by up to 20%. On longer missions (3-6 months), a 30% loss has been noted. The fundamental cause of this muscle atrophy is the absence of gravitational loading on bones and muscles during space flight. Muscle unloading results in biochemical and structural changes. In concert with atrophy, muscles also lose strength. Following short flights, a 12% loss of peak knee extension torque was measured, and a 31% loss was noted after a long flight.

Extended periods in environments with zero or near zero gravity (“microgravity”) such as a space station can lead to a reduction of approximately 30% in muscle mass, concomitant with a decline in muscle strength. For example, the maximal voluntary contraction of the human plantar flexor muscles declined by 20-48% following 6 months in space.

### SUMMARY

A human must constantly exercise to combat muscle atrophy in a microgravity environment. It would be advantageous if such exercise can be enjoyable to provide motivation.

A space station may have numerous extremely sensitive or delicate equipment. It would be advantageous if exercise can be performed in a manner that avoids damage to such equipment.

In view of the problems discussed above, as well as other concerns, the present disclosure concerns a space wings suit that can be worn by a human in a microgravity environment for enjoyable exercise in a safe manner.

As shown in FIG. 6, the suit includes two wing portions, a base portion between the two wings and a plurality of straps. The wing portion can include a wire portion that connects to a handle.

The top height of the wings can be set to be less than or equal to the height of the wearer to reduce the likelihood that the wings will damage sensitive equipment. For the same reason, the width of the wings can be set so that when fully extended, the wings do not go past palm of hand of wearer. A handle can be connected to wire going around wings so the wearer can flutter wings.

The suit can have, for example, two straps on a shoulder portion of the suit, one strap at the waist portion and one at each wrist portion.

During use, a user can move efficiently in the microgravity environment by extending and retracting the wings like a bird.

The wings and base portion can include a foam interior portion and an exterior portion made from flexible material. Alternatively, the suit can be made entirely from foam. Fans can be included for the feet of the wearer.

### BRIEF DESCRIPTION OF THE DRAWINGS

FIG. 1 depicts a front view of the space wings suit operated in a closed state according to an exemplary embodiment.

FIG. 2 depicts a front view of the space wings suit operated in an open state according to an exemplary embodiment.

FIG. 3 depicts a rear view of the space wings suit operated in an open state according to an exemplary embodiment.

FIG. 4 depicts a rear view of the space wings suit operated in a closed state according to an exemplary embodiment.

FIG. 5 depicts a top view of a fin for the space wings suit on the foot of a user.

FIG. 6A is a diagram illustrating the space wings suit according to an exemplary embodiment.

FIG. 6B is a diagram illustrating an interior portion of the space wings suit shown in FIG. 6A.

FIG. 6C is a diagram illustrating a cross-section of the wings suit along line VIC-V1C of FIG. 6A.

FIG. 6D is a diagram illustrating a cross-section of the wings suit along line VID-V1D of FIG. 6A.

FIG. 7A is a top view of a fin of the space wings suit.

FIG. 7B is a side view of the fin shown in FIG. 7A.

FIG. 8A is a diagram illustrating the space wings suit according to an alternative embodiment.

FIG. 8B is a diagram illustrating a cross-section of the wings suit along line VIIIB-VIIIB of FIG. 8A.

### DETAILED DESCRIPTION OF EMBODIMENTS

The accompanying figures, in which like reference numerals refer to identical or functionally similar elements, together with the detailed description below are incorporated in and form part of the specification and serve to further illustrate various exemplary embodiments and explain various principles and advantages in accordance with the present invention.

Hereinafter, referring to the drawings as needed, exemplary embodiments will be described in detail. However, more detailed description than necessary may be omitted. For example, detailed description of well-known items or overlapping description of substantially the same configurations may be omitted. This is to avoid unnecessary redundancy in the following description, and facilitate understanding of those in the art. The accompanying drawings and the following description are provided for those in the art to sufficiently understand the present disclosure and are not intended to limit the subject described in the claims.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions.

Reference will now be made in detail to the accompanying drawings. Wherever possible, the same reference numbers will be used throughout the drawings to refer to the same or like parts.

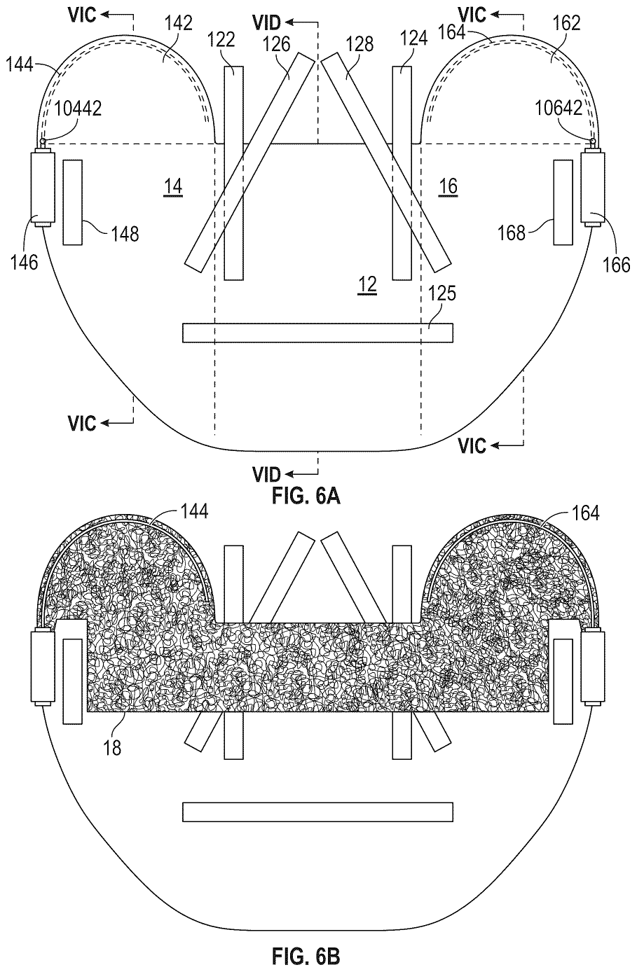

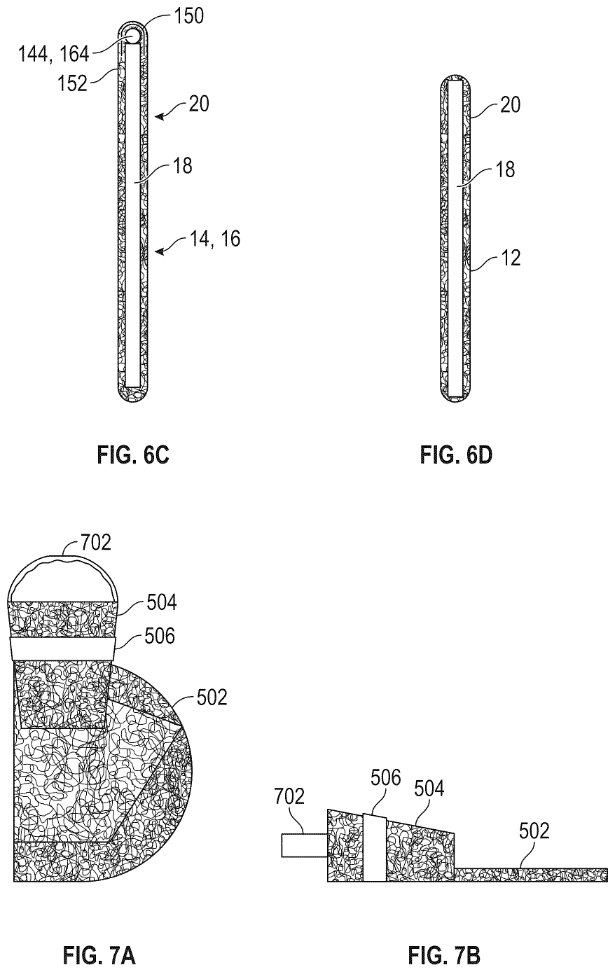

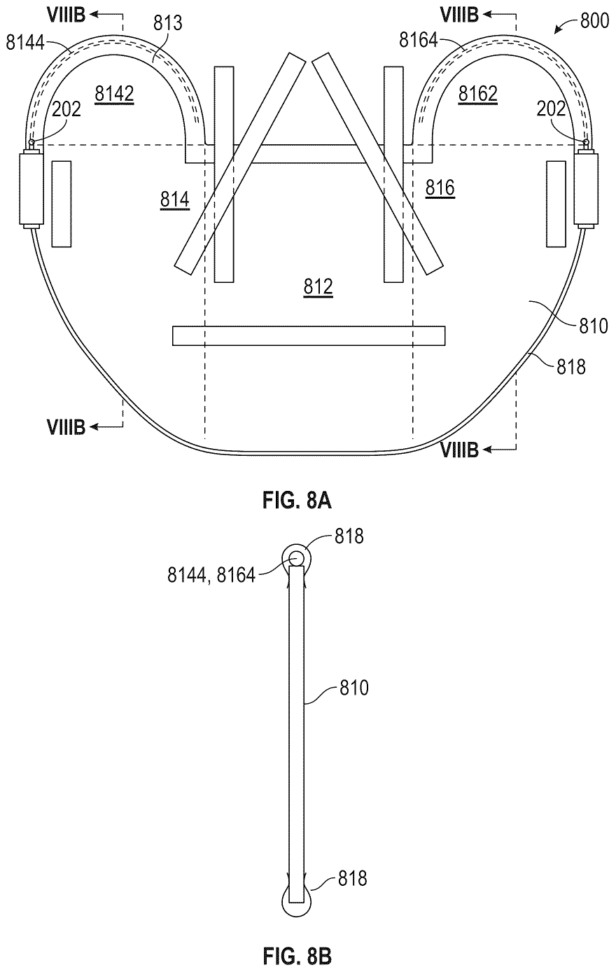

Referring to FIGS. 6A-6D, an exemplary implementation of a space wings suit for being operated by a user in a microgravity environment for exercise according to an exemplary embodiment will be discussed. The exemplary space wing suit 10 includes a base portion 12, first wing portion 14 and second wing portion 16. The first and second wing portions 14, 16 extend from the base portion 12. The user will be referred to as a pilot.

As shown in FIGS. 6C-6D, the wing portions 14, 16 and base portion 12 include an interior layer 18 surrounded by a flexible exterior layer 20. As shown in FIG. 6B, the interior layer 18 can be made from foam such as 5 mm shape retention EVA foam. The exterior layer 20 can be made from elastic material such as a 60″ wide roll of cotton spandex fabric that is flexible, stretchable and, lightweight. The exterior layer 20 can be attached to the interior layer 18 by fabric glue.

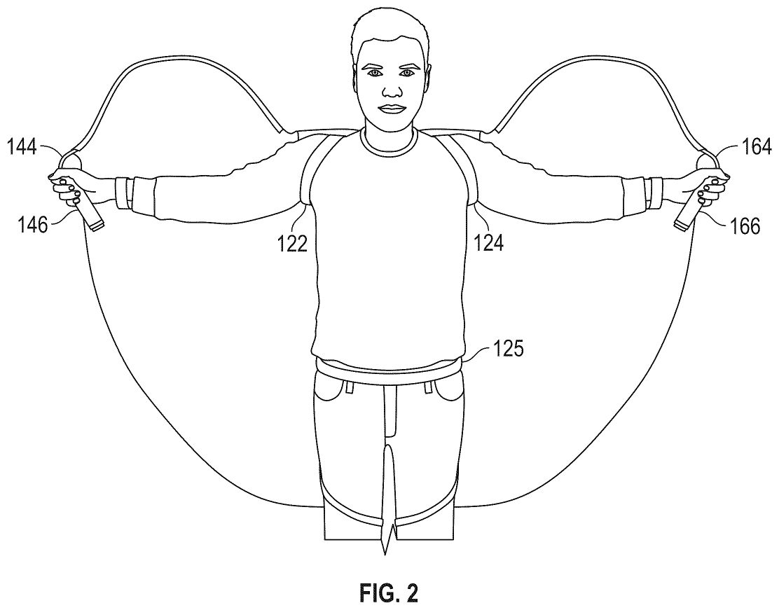

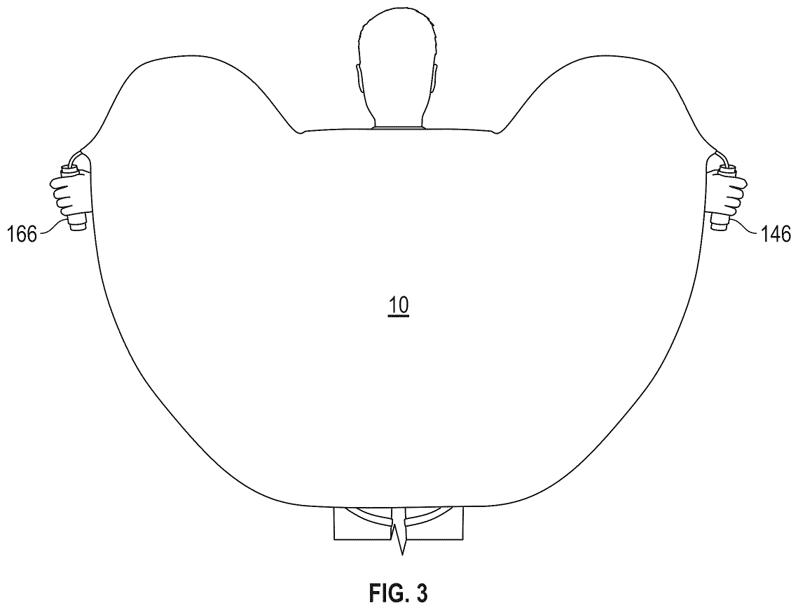

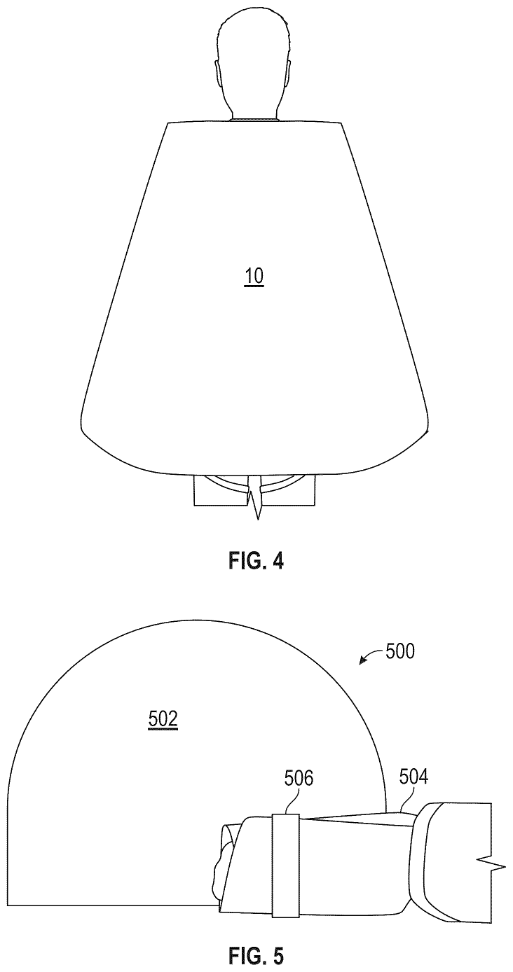

Returning to FIG. 6A, each of the first and second wing portions 14, 16 includes: an upper portion 142, 162 protruding above a top of the base portion 12; a wire cable 144, 164 having a first end protruding from an opening 10442, 10642 (145, 165 in FIG. 2) in the exterior layer 20 and a second end connected to the interior layer 18; a handle 146, 166 attached to the first end of the wire cable 144, 164; and an arm strap 148, 168 connected to the exterior layer 20.

The wire cable 144, 164 can be a pure copper 3 conductor such as 14 Gauge 100% Pure Copper 2 Conductor 14/2 Flexible Shielded Wire 15 FT, UL2464 14AWG 2 Core EMI/RFI Shielding Shielded Cable. The wire cable can also be a nylon Insulated Stranded Pure Copper Wire such as XRDS-RF 10 AWG 25 FT THHN Stranded Wire. The wire cable can have a 1 cm diameter. Importantly, the wire cable must be thick enough to be bent into shape, hold its shape, and, when operated by the handles, maintains its shape when the upper wings are bent forwards. The wire cable 144, 164 can be connected to the interior layer 18 by duct tape 152 (shown in FIG. 6C) on the top of the protruding portions 142, 162 (shown in FIG. 6B).

The handles 146, 166 attached to the wire cables 144, 164 can be mountain bike grips with lock ring fastening and grip surface such as MTB Grips made by Eastern Power. The handles 146, 166 can include bike lock-on grip systems such as those made by ECSiNG.

The upper portions 142, 162 of the wings protruding above the top of the base portion 12 have a semi-circular shape. A maximum height of the upper portions 142, 162 is no greater than 25 percent larger than a maximum height of the base portion. For example, in the example shown in FIG. 6A, the maximum height of the upper portions 142, 162 is 12 inches higher than a maximum height of the base portion. This configuration is necessary for preventing the wings from being higher than the pilot's head.

The outer perimeter of the upper portion of the wing portions can include a passage 150 (with opening 145, 165). The wire cable 144, 164 can be disposed in the passage 150.

The sides of the wing portions 14, 16 that connect to the upper portions have a curvature shape. A width of each of the first and second wing portions 14, 16 decreases from a bottom of the upper portion substantially flush with a top of the base portion to a lowest part of said wing portion substantially flush with a bottom of the base portion. A maximum width of each of the first and second wing portions 14, 16 is less than a maximum width of the base portion 12. This configuration is necessary for preventing the wings from being substantially longer than the arms of the pilot.

Be preventing the wings from being substantially longer than the arms of the pilot and the wings from being higher than the pilot's head, the suit can be used in a manner that reduces risk of damages to sensitive equipment in a microgravity environment.

The base portion 12 includes: first and second shoulder straps 122, 124 connected to the exterior layer 20 and extending from the top in a vertical direction; and a waist strap 125 connected to the exterior layer 20 and extending in a horizontal direction below the first and second should straps 122, 124. Alternatively, the base portion 12 can further include third and fourth shoulder straps 126, 128. Top portions of the third and fourth straps are disposed 126, 128 on the exterior layer and inside of the first and second shoulder straps 122, 124 and bottom portions of the third and fourth adjustable straps 126, 128 are disposed on the exterior layer and outside of the first and second shoulder straps 122, 124.

Referring to FIG. 5 and 7A-7B, the suit can also include first and second fins 500 for being worn at the pilots'feet. The fin 500 includes a flap 502 that has a semi-circular shape. The fin 500 includes an insert layer 504 on the flap 502. The insert layer 504 includes a touch fastener for securing it on the foot of a user. The flap 502 and insert layer 504 are made of foam. The fin 500 also includes a strap 506 for further securing the flap to the user. As shown in FIGS. 7A-7B, the fins 500 can further include an ankle strap 702.

Each of the straps includes a touch fastener so that they can be adjusted around the waist, shoulder or arm of the user. The touch fastener can be VELCRO® or other brand “hook and loop rolls” 1.5 inches wide; both hook roll and loop roll have an adhesive side. The straps can be 2″ Strap and Buckles Set with Side Release (Quick Release) Buckles. The buckles can be watch-type or belt-type.

For a pilot of height 5 foot 7 inches, the suit can be made from a EVA foam (47 in by 56 in) Cotton Spandex Fabrick (47 in by 56 in). If the EVA foam is not large enough or thick enough, a special cement or glue can be used to attach the pieces together.

### Making the Space Wings Suit

The cotton spandex is cut based upon a cardboard template of the shape of the suit with an extra two inches in all directions.

The EVA foam is cut based upon the cardboard template.

The wire cables are shaped to fit around the upper portions of the wings while leaving extra length for the handles and cut. The cables are attached to the EVA foam by duct tape.

One side at a time, glue is spread over the EVA foam and covered with cotton spandex starting at one end and smoothing out the creases to reduce wrinkles as the cotton-spandex is spread over the EVA foam.

The cotton-spandex will have extra length. One front side cotton-spandex will be wrapped around the back side to the foam and attached via fabric glue. The back side will wrap around to the front side and be sewn to the cotton-spandex of the front side.

The handles are attached to the extended cable and tightened with lock rings. Additional lock rings that are the approximate diameter of the cable are added under the handle bars if necessary.

The waist strap is attached to the exterior layer. An adhesive VELCRO® strip the length of his waist (hooks up) is attached to the suit, with enough extra to wrap around the waist; this extra should not have the adhesive exposed. A VELCRO® strip (loops up) is attached to the attached VELCRO® strip, with enough extra to wrap around the waist; this strip should have no exposed adhesive. These steps are repeated for the arm straps. If necessary, depending on the physique of the pilot, the additional two pairs of arm straps can be attached to prevent the suit from slipping from shoulders.

The fins can be made by cutting EVA foam. Vinyl/fabric glue or EVA contact cement can be used to attach the pieces to each other.

### Alternative Embodiments

In an alternative embodiment, the wings suit 800 includes a foam sheet 810 but not a flexible exterior layer. The foam sheet 810 includes a base portion 812; and first and second wing portions 814, 816 extending from the base portion 812, wherein each of the first and second wing portions 814, 816 includes an upper portion 8142, 8162 protruding above a top of the base portion 812 like the first embodiment. The wings suit 800 includes a strap portion 818 at least on outer peripheries of the upper portions 8142, 8162. The wire cables 8144, 8164 protrude from openings 202 in the strap portions. The straps are attached to the foam sheet 810.

The strap portion can be an ApexOne Heavy Duty Hook & Loop Cable Tie Cord Wrap Fastener Nylon Power Cord Management Wire Organizer Strap hat is 4 inches. The strap portion can be wrapped around the wire cables and sewn to the foam sheet 810.

The wing suit is made by first creating a cardboard template of the suit. The cardboard template is placed on EVA foam. The template shape is traced on the EVA foam and the foam is cut using the template.

The cables are shaped to fit around upper wing semi-circles while leaving extra length for the handle attachments and cut.

The wire cables 8144, 8164 are attached to the upper semi-circles of the upper portions 8142, 8162 using a 4″ strap portion 818. The strap portion is wrapped around the upper edges of the semi-circles of the upper semi-circles of the upper portions 8142, 8162 and sewed tightly to secure the wire cables 8144, 8164 in place.

The handles are attached to the extended cables lengths and tightened with lock rings. Add additional lock rings that are the approximate diameter of the cable under the handle bars are added if necessary.

The waist strap is attached by sewing 2″ strap-and-buckle set to the foam layer, ideally as a single, adjustable strap, such that the two loose ends will wrap around the waist, fit snugly around the waist and attach in front of the waist as a belt. The strap can be adjustable in either of two ways: (1) as a belt buckle with adjustable holes for the prong, or (2) with adjustable tri-glide sliders. The latter have side-release snap buckles

The arm straps are also attached to the foam sheet by sewing. The suit can include, for example, a single pair of 2″ arm straps or two pair of 1″ arm straps to hold the suit to the user.

The wire cable 144, 164 can be attached to the foam interior layer 18 by duct tape. Alternatively, a small strap can

It should be noted that sewing through EVA foam requires a sharp, sturdy needle. A professional machine would be required to sew interior regions of the Space Wings.

### Operation

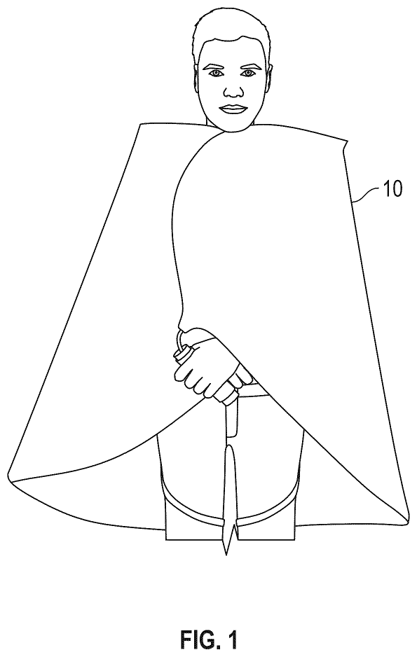

As shown in FIG. 1, the pilot secures the shoulder straps around her shoulders, the arm straps around her wrists, and the waist straps around her waist. The touch fastener is used to adjust the straps and ensure a secure and comfortable fit. The pilot holds the handles. FIG. 1 shows the suit in a fully open state similar to a bird extending its wings. As shown in FIG. 2, the pilot can place the suit in a closed state in which one of the first and second wings is folded over the other.

Returning to FIG. 1, if the pilot uses the cables to pull the protruding portions of the wings downward towards her feet in a motion similar to a breast stroke swim motion, the pilot will accelerate.

In a microgravity environment, air drag create decelerations. Accordingly, the pilot can decelerate by pulling the protruding portions of the wings to be perpendicular to the direction of motion.

The fins can be used for further acceleration or deceleration. When the pilot positions the fins to be substantially parallel with a vertical direction of the base portion, the wing suit is in an acceleration state. When the pilot positions the fins to be substantially perpendicular to a vertical direction of the base portion, the wing suit is in a deceleration state.

Other embodiments will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A wings suit comprising:
a base portion; and
first and second wing portions extending from the base portion,
where each of the base portion, first wing portion and second wing portion includes an interior layer surrounded by a flexible exterior layer,
wherein each of the first and second wing portions includes:
an upper portion protruding above a top of the base portion;
a wire cable having a first end protruding from an opening in the exterior layer and a second end securely connected to the interior layer;
a handle attached to the first end of the wire cable;
an arm strap adjustably connected to the exterior layer;
wherein the base portion includes:
first and second shoulder straps adjustably connected to the exterior layer and extending from the top in a vertical direction; and
a waist strap adjustably connected to the exterior layer and extending in a horizontal direction below the first and second should straps.

2. The wings suit of claim 1, wherein the upper portion of each of the first and second wing portions protruding above the top of the base portion has a semi-circular shape.

3. The wings suit of claim 1, wherein the upper portion of each of the first and second wing portions protruding above the top of the base portion has a maximum height that is no greater than 25 percent larger than a maximum height of the base portion.

4. The wings suit of claim 1, where a maximum height of the upper protruding portion is 12 inches higher than a maximum height of the base portion.

5. The wings suit of claim 1, wherein a width of each of the first and second wing portions decreases from a bottom of the upper portion substantially flush with a top of the base portion to a lowest part of said wing portion substantially flush with a bottom of the base portion.

6. The wings suit of claim 1, wherein a maximum width of each of the first and second wing portions is less than a maximum width of the base portion.

7. The wings suit of claim 1, wherein the wire cable is disposed in an interior passage along an outer perimeter of the upper portion of the first and second wing portions.

8. The wings suit of claim 1, wherein the wire cable is disposed in a passage along a seam in an outer perimeter of the upper portion of the first and second wing portions.

9. The wings suit of claim 1, wherein the interior layer is made of foam.

10. The wings suit of claim 1, the base portion further including third and fourth adjustable should straps, wherein top portions of the third and fourth adjustable straps are disposed on the exterior layer and inside of the first and second shoulder straps and bottom portions of the third and fourth adjustable straps are disposed on the exterior and outside of the first and second shoulder straps.

11. The wing suit of claim 1, wherein the exterior layer is made of spandex.

12. The wings suit of claim 1, wherein the arm strap includes a touch fastener.

13. The wings suit of claim 1, wherein each of the shoulder straps includes a touch fastener.

14. The wings suit of claim 1, further comprising:
first and second fins, each of the fins including:
a foam flap; and
an insert layer disposed on the foam flap, the insert layer including an attachment portion for securing the insert layer on a foot of a user.

15. The wings suit of claim 14, wherein the foam flap of the first and second fins has a semi-circular shape.

16. The wings suit of claim 14, wherein the foam flap includes at least two foam layers connected together.

17. A wings suit comprising:
a foam sheet having a base portion, and first and second wing portions extending from the base portion, wherein each of the first and second wing portions includes an upper portion protruding above a top of the base portion;
a strap portion on outer peripheries of the upper portions;
wire cables having a first end protruding from openings in the strap portion;
handles attached to the first ends of the wire cables;
first and second arm straps on the first and second wing portions, respectively;
first and second shoulder straps extending from the top of the base portion in a vertical direction; and
a waist strap extending in a horizontal direction below the first and second should straps.
